(19) United States
(12) Patent Application Publication
(10) Pub. No.: US 2009/0006956 A1
(43) Pub. Date: Jan. 1, 2009

(54) METHOD AND APPARATUS FOR DISPLAYING INFORMATION

(75) Inventors: Hee-jeong BAE, Suwon-si (KR); Jung-won Lee, Seongnam-si (KR); Joon-kyu Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/017,403

(22) Filed: Jan. 22, 2008

(30) Foreign Application Priority Data
Jun. 28, 2007 (KR) 10-2007-0064619

(51) Int. Cl. G06F 3/048

(52) U.S. Cl. 715/708; 715/808

(57) ABSTRACT

An information display method and apparatus are provided. The information display method includes opening a popup window that displays information regarding a first location of a screen; moving the popup window to a second location if a movement command is input; and displaying information regarding the second location in the popup window.

### BACKGROUND OF THE INVENTION

This application claims priority from Korean Patent Application No. 10-2007-0064619, filed on Jun. 28, 2007, in the Korean Intellectual Property Office, the disclosure of which is incorporated herein in its entirety by reference.

### FIELD OF THE INVENTION

Methods and apparatuses consistent with the present invention relate to displaying information.

### DESCRIPTION OF THE RELATED ART

Office devices such as printers or multifunctional devices are devices used by a wide range of office workers. Thus, users' ability to learn functions of such office devices is limited and as the office devices are unfamiliar to the users it will make it difficult to use and access them properly. To overcome this disadvantage, office devices provide users with help about the use of functions. However, since execution of a help mode changes a full screen to the help mode, users are disconnected from a previous execution screen.

FIGS. 1A through 1C are images of conventional help information display screens. In more detail, FIG. 1A shows a 2up menu 121 that is selected or highlighted from among sub menus of a N-up menu 120 indicating that a plurality of current pages are copied on a sheet. FIG. 1B shows a help screen 122 regarding the 2up menu 121 when a help icon 110 of FIG. 1A is selected and the help is executed. FIG. 1C shows a help item list screen 131 when a contents tab 130 is selected in order to see help regarding a function other than the N-up menu 120 or the 2up menu 121. On the help item list screen 131, users need to search for desired help items from a tree structure of help items 1-1 through 1-9. That is, when users want to continuously see help regarding several functions, it is inconvenient to users to search for help items of the tree structure.

Further, when users want to see help regarding a process of executing a function, since users are required to escape from the help item list screen 131 in order to execute the function, i.e., the help and an execution screen are separated from each other, users must memorize or print content of help regarding a process of executing all functions and execute a desired function.

### SUMMARY OF THE INVENTION

Exemplary embodiments of the present invention provide a method and apparatus for displaying information by which help information regarding various functions can be easily provided via a help window that is always displayed on a screen and is seen during the execution of a function.

According to an aspect of the present invention, there is provided a method information display method comprising: opening a popup window that displays information regarding a first location of a screen; moving the popup window to a second location if a movement command is input; and displaying information regarding the second location in the popup window.

The moving of the popup window to the second location may comprise: dragging and dropping the popup window to the second location.

The information regarding the first location and the second location is help information regarding a first function and a second function corresponding to the first and second locations.

The opening of the popup window may comprise: if a help mode is selected, obtaining the help information regarding a function corresponding to a location that is currently selected on the screen and displaying the help information in the popup window.

The method may further comprise: if an execution mode is selected, continuously displaying the help information regarding the function corresponding to the second location on the popup window even if the popup window is moved to a third location.

The method may further comprise: if the execution mode is selected, changing the screen to a mode where the function corresponding to the second location is executed while the popup window is maintained open.

The method may further comprise: changing the help information displayed on the popup window according to a process of executing the function corresponding to the second location.

According to an aspect of the present invention, there is provided an information display apparatus comprising: an input unit to input commands; a display unit displaying information; a storage unit storing information regarding one or more locations of a screen that are output on the display unit; and a control unit, when a movement command instructing a popup window to move from a first location to a second location is input through the input unit, obtaining information regarding the second location from the storage unit and controlling the display unit to move the popup window to the second location and display the obtained information on the popup window.

The input unit may be a touch screen.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1C are images of conventional help information display screens;

FIG. 2 is a block diagram illustrating an information displaying apparatus according to an exemplary embodiment of the present invention;

FIG. 3 is a flowchart illustrating an information display method according to an exemplary embodiment of the present invention;

FIGS. 4A through 4D are images of screens on which a help information display method is applied according to an exemplary embodiment of the present invention; and

FIGS. 5A through 5D are images of screens on which an execution mode is selected in a help mode according to an exemplary embodiment of the present invention.

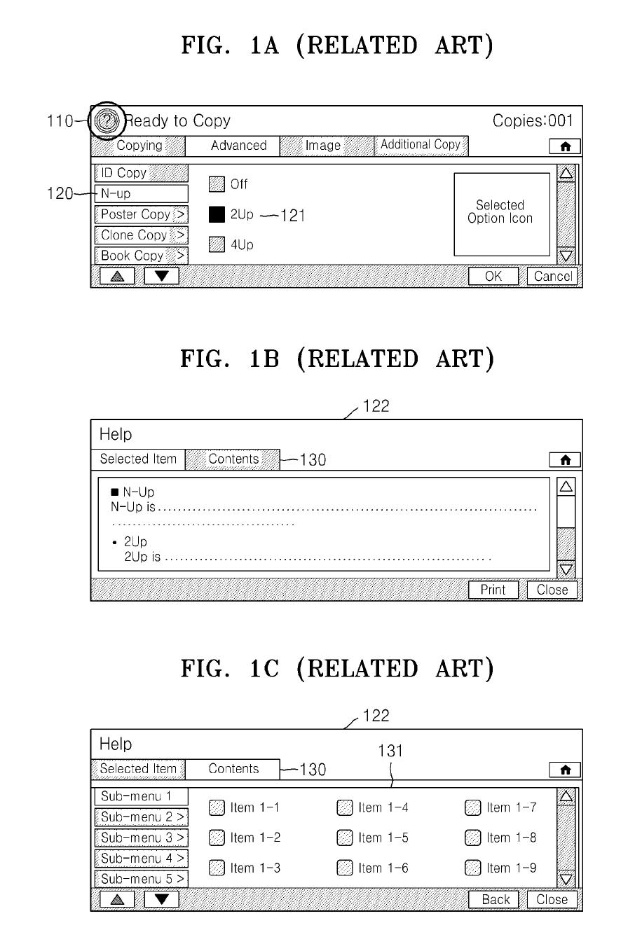

### DETAILED DESCRIPTION OF EXEMPLARY EMBODIMENTS OF THE INVENTION

Exemplary embodiments of the present invention will now be described more fully with reference to the accompanying drawings.

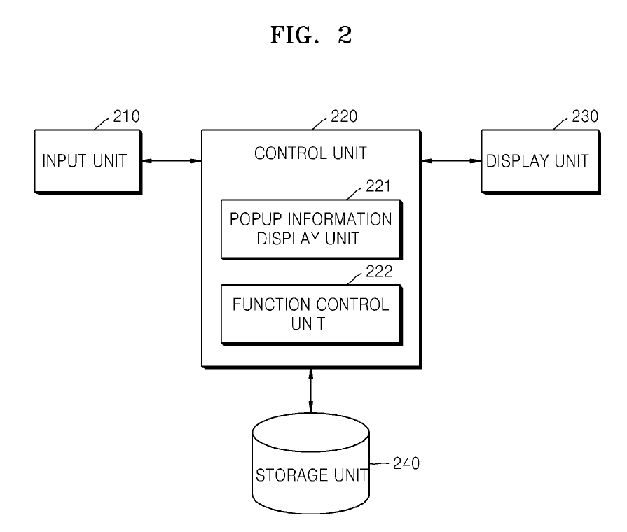

FIG. 2 is a block diagram illustrating an information displaying apparatus according to an exemplary embodiment of the present invention. Referring to FIG. 2, the information displaying apparatus comprises an input unit 210 that is used to input a plurality of user commands, a display unit 230 that outputs information, a storage unit 240 that stores information regarding one or more locations on a screen that are output on the display unit 230, and a control unit 220 that generally controls the information displaying apparatus and executes user commands that are input to the input unit 210.

The input unit 210 may be a touch screen based input device. The storage unit 240 stores information regarding the information displaying apparatus, i.e., the information regarding one or more locations on the screen. For example, the storage unit 240 can store help information corresponding to each menu displayed on the screen. The present invention is not limited to a method of storing or searching for the information stored in the storage unit 240. The information can be stored in the form of a file, searched using an index, or stored in a database.

The control unit 220 includes a popup information display unit 221 that opens a popup window and displays information regarding a predetermined location of the screen, and a function control unit 222 that controls the function of the information display apparatus within the popup window or with the popup window open.

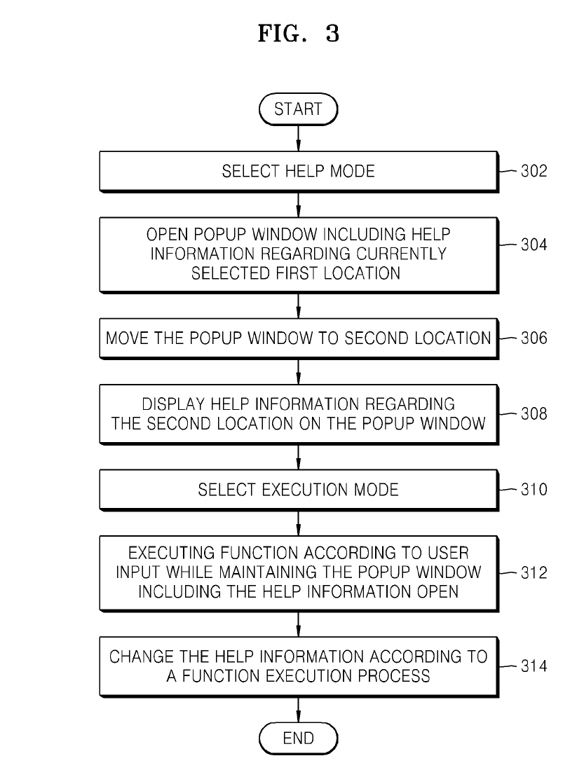

User commands that may be input to the input unit 210 include a command that instructs the opening of the popup window, the window including a predetermined type of information, a movement command that instructs the movement of the popup window, an execution mode conversion command that instructs the conversion of the screen into an execution mode where the function of the information display apparatus is executed within the popup window, and the like. The predetermined type of information is information regarding one or more location of the screen, which can be help information regarding a function corresponding to each location. However, the present invention is not limited thereto. The movement command can be input by the user into the input unit 210 by dragging and dropping the popup window. If the user inputs a command that instructs the popup window to move from a first location to a second location, the popup information display unit 221 searches and obtains information regarding the second location from the storage unit 240, moves and displays the popup window to the second location, and controls the display unit 230 to display the information regarding the second location within the popup window. Hereinafter the function of the control unit 220 will now be described with reference to FIGS. 3 through 5D.

FIG. 3 is a flowchart illustrating an information display method according to an exemplary embodiment of the present invention. Referring to FIG. 3, if a user selects a help mode using the input unit 210 (Operation 302), the popup information display unit 221 detects a first location that is currently selected or highlighted, searches for help information regarding a function corresponding to the first location from the storage unit 240, opens a popup window, and displays the help information on the popup window (Operation 304). The popup window may be opened at the first location or opened at a location or in a manner that the user can recognize the popup window to be related to the first location. If the user moves the popup window to a second location (Operation 306), the popup information display unit 221 searches for help information regarding a function corresponding to the second location from the storage unit 240 and refreshes the popup window according to the information (Operation 308).

If the user selects an execution mode using the input unit 210 in a help mode (Operation 310), the user does not close the popup window displaying the help information but maintains it open and executes a function according to a user input (Operation 312). In more detail, if the user selects or clicks a specific icon within the popup window, the function control unit 222 executes a function corresponding to the icon, or if the user selects a function menu beyond the popup window while the popup window is opened, the function control unit 222 executes a function corresponding to the function menu. In the execution mode, although the popup window moves to a third location the popup information display unit 221 does not display help information regarding the third location on the popup window but continuously displays help information regarding a function corresponding to the second location, so that the user can execute the function while seeing the help information regarding the second location. When the function requires a plurality of operations, the popup information display unit 221 changes help information according to each operation being performed, and displays the help information (Operation 314).

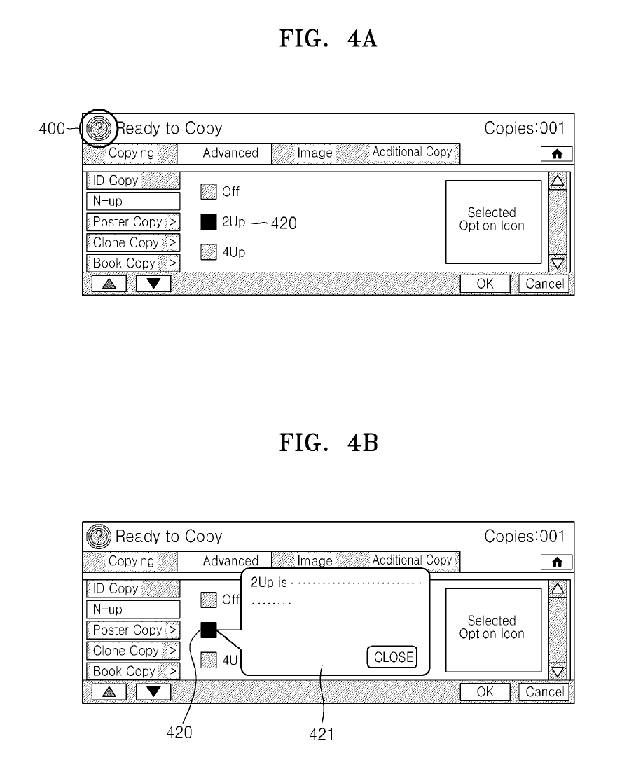

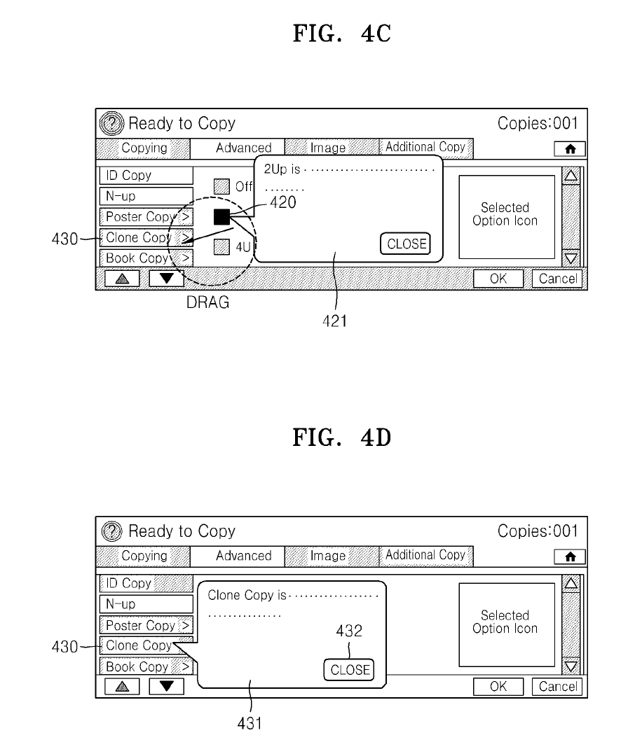

FIGS. 4A through 4D are images of screens on which a help information display method is applied according to an exemplary embodiment of the present invention. Referring to FIG. 4A, when a user selects a help icon 400 and executes a help function, i.e., when the user selects a help mode, a help popup window 421 regarding a currently highlighted 2up menu 420 is displayed as shown in FIG. 4B. The help popup window 421 may have a shape and location so that it can be easily understood to be related to a specific function. In the present exemplary embodiment, the help popup window 421 has a horse-shaped balloon. However, the present invention is not limited thereto.

Referring to FIG. 4C, the help popup window 421 moves to another menu 430 in a drag & drop manner. Referring to FIG. 4D, a help popup window 431 reflects the location and content of the help popup window 421 that has moved. In more detail, the help popup window 431 is on a clone copy menu 430 and displays help information regarding the clone copy menu 430. The help popup window 431 is closed when a user selects a close button 432 instructing to close the popup window. If the help popup window 431 is closed, a current screen is restored to the screen of FIG. 4A.

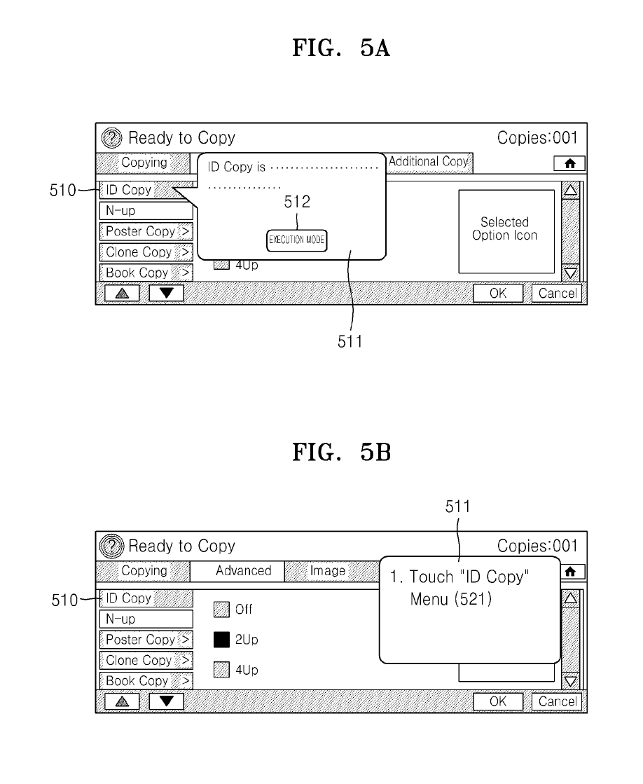

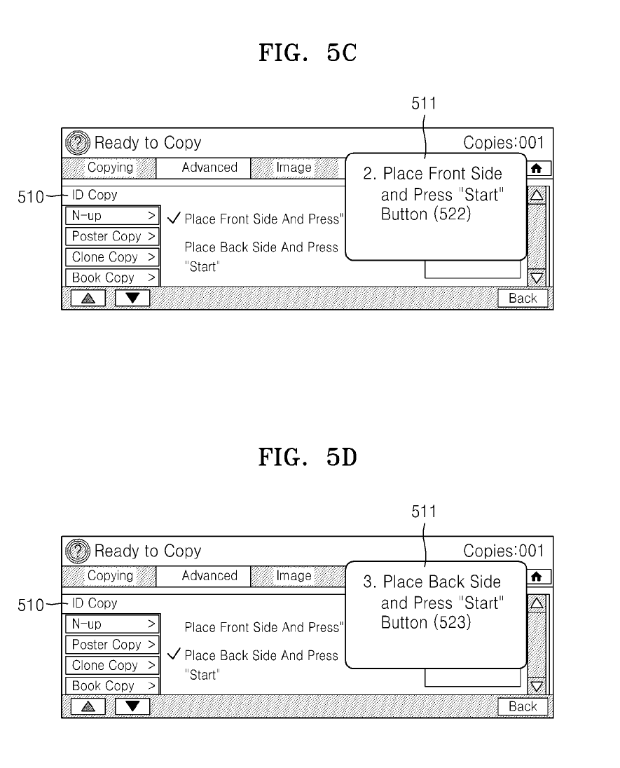

FIGS. 5A through 5D are images of screens on which an execution mode is selected in a help mode according to an exemplary embodiment of the present invention.

When help information displayed on a popup window relates to a process of executing a predetermined function, the popup window is provided in an image or text animation manner and can be converted into an execution mode. Referring to FIG. 5A, an execution mode button 512 is selected from a help popup window 511 regarding an ID Copy menu 510, and help information 521 regarding a first process of executing a function corresponding to the ID Copy menu 510 is displayed on the help popup window 511 as shown in FIG. 5B. The help popup window 511 moves to the top right of a screen in order to prevent a user from being interrupted executing the function. In more detail, the help popup window 511 automatically moves in order to show the user buttons to be used to execute the function corresponding to the ID Copy menu 510.

If the user selects the ID Copy menu 510 according to the help information 521 and performs the first process, help information 522 regarding a second process of executing the function is displayed on the help popup window 511 as shown in FIG. 5C. If the user places a front side of an object on a copy board and selects a Start button according to the help information 522, help information 523 regarding a third process of executing the function is automatically displayed on the help popup window 511 as shown in FIG. 5D.

The present invention can also be embodied as computer readable code on a computer readable recording medium.

According to the present invention, a user can easily see help regarding various functions by merely dragging and dropping a help window on a function button of which help is desired. Further, the user can see help reflecting a current execution process in real time while executing a function, thereby facilitating easy operation of a device.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An information display method comprising:
opening a popup window that displays information regarding a first location of a screen;
moving the popup window to a second location if a movement command is input; and
displaying information regarding the second location in the popup window.

2. The method of claim 1, wherein the moving of the popup window to the second location further comprises dragging and dropping the popup window to the second location.

3. The method of claim 1, wherein the information regarding the first location and the second location is help information regarding a first function and a second function corresponding to the first and second locations.

4. The method of claim 3, wherein the opening of the popup window further comprises if a help mode is selected, obtaining the help information regarding a function corresponding to a location that is currently selected on the screen and displaying the help information in the popup window.

5. The method of claim 3, further comprising:
if an execution mode is selected, continuously displaying the help information regarding the function corresponding to the second location on the popup window even if the popup window is moved to a third location.

6. The method of claim 3, further comprising:
if the execution mode is selected, changing the screen to a mode where the function corresponding to the second location is executed while the popup window is maintained open.

7. The method of claim 5, further comprising:
changing the help information displayed on the popup window according to a process of executing the function corresponding to the second location.

8. A computer readable medium having embodied thereon a computer program for executing an information display method comprising:
opening a popup window that displays information regarding a first location of a screen;
moving the popup window to a second location when a movement command is input; and
displaying information regarding the second location in the popup window.

9. An information display apparatus comprising:
an input unit to input commands;
a display unit which displays information;
a storage unit which stores information regarding one or more locations of a screen that are output on the display unit; and
a control unit which, when a movement command instructing a popup window to move from a first location to a second location is input through the input unit, obtains information regarding the second location from the storage unit and which controls the display unit to move the popup window to the second location and display the obtained information on the popup window.

10. The apparatus of claim 9, wherein the input unit is a touch screen.

11. The apparatus of claim 9, wherein the movement command is input when a user drags and drops the popup window to the second location.

12. The apparatus of claim 9, wherein the information regarding one or more locations is help information regarding a function corresponding to each location.

13. The apparatus of claim 12, wherein, if a help mode is selected through the input unit, the control unit obtains the help information regarding a function corresponding to a location that is currently selected on the screen, and displays the help information on the popup window.

14. The apparatus of claim 12, wherein, if an execution mode is selected through the input unit, the control unit continuously displays the help information regarding the function corresponding to the second location on the popup window although the popup window is moved to a third location.

15. The apparatus of claim 12, wherein, if the execution mode is selected through the input unit, the control unit changes the screen to a mode where the function corresponding to the second location is executed while maintaining the popup window open.

16. The apparatus of claim 14, wherein the control unit changes the help information displayed on the popup window according to a process of executing the function corresponding to the second location.
